(19) United States
(12) Patent Application Publication
(10) Pub. No.: US 2023/0267416 A1
(43) Pub. Date: Aug. 24, 2023

(54) INCREMENTAL IMPLEMENTATION FRAMEWORK FOR DATA AND AI STRATEGY

(71) Applicant: International Business Machines Corporation, Armonk, NY (US)

(72) Inventors: Paul Christensen, Camp Hill, PA (US); Elizabeth Ackerman, Phoenix, AZ (US); Kyle Gene Brown, Durham, NC (US)

(21) Appl. No.: 17/676,948

(22) Filed: Feb. 22, 2022

(51) Int. Cl. G06Q 10/10; G06Q 10/06

(52) U.S. Cl. CPC G06Q 10/103; G06Q 10/101; G06Q 10/06393; G06Q 10/06375; G06Q 2220/10

(57) ABSTRACT

An example operation may include one or more of displaying, via a uniform resource location (URL), a user interface for data and artificial intelligence (AI) planning, incrementally populating the user interface with different dedicated content areas for different objectives of the cloud implementation, incrementally detecting content that is added to the different dedicated content areas of the user interface via user devices of a collaboration of users, detecting votes submitted via the user interface by the user devices regarding the detected content, and generating an ordered sequence of actions to perform for implementing a cloud platform and displaying the ordered sequence of actions via the user interface.

### BACKGROUND

The creation of an executable and well-defined data and artificial intelligence (AI) strategy is elusive to many organizations. As a result, these organizations are often unable to use data and data science as a competitive advantage in support of their business objectives and priorities. Traditional approaches to “data and AI strategy” focus on high-level organizational goals, data management principles, roles, and responsibilities, but do not provide guidance on implementing this strategy. The sheer number of stakeholders and interviews is costly and can take months to complete. These monolithic projects are difficult to breakdown into incremental value. As a result, many factors are considered in isolation and without collaboration from the company as a whole.

In addition, prior approaches to “data and AI strategy” focus on near-sighted or short-term rewards, technology capabilities, and a few business use cases. This narrow focus does not address the need to support a cross-functional business strategy (e.g., across multiple sub-groups within a complex organization, etc.) for large organizations that rely on a cloud platform to host the organization's data and applications, nor does it adequately surface organizational blocking factors that prevent achievement of business goals.

### SUMMARY

One example embodiment provides an apparatus that includes a memory configured to store program instructions, and a processor coupled to the memory and configured to execute the program instructions, wherein, in response to execution of the program instructions, the processor is configured to one or more of display, via a uniform resource location (URL), a user interface for data and artificial intelligence (AI) planning, incrementally populate the user interface with different dedicated content areas for different objectives of the cloud implementation, incrementally detect content that is added to the different dedicated content areas of the user interface via user devices of a collaboration of users, detect votes submitted via the user interface by the user devices regarding the detected content, and generate an ordered sequence of actions to perform for implementing a cloud platform and display the ordered sequence of actions via the user interface.

Another example embodiment provides a method that includes one or more of displaying, via a uniform resource location (URL), a user interface for data and artificial intelligence (AI) planning, incrementally populating the user interface with different dedicated content areas for different objectives of the cloud implementation, incrementally detecting content that is added to the different dedicated content areas of the user interface via user devices of a collaboration of users, detecting votes submitted via the user interface by the user devices regarding the detected content, and generating an ordered sequence of actions to perform for implementing a cloud platform and displaying the ordered sequence of actions via the user interface.

A further example embodiment provides a computer-readable medium comprising instructions, that when read by a processor, cause the processor to perform one or more of displaying, via a uniform resource location (URL), a user interface for data and artificial intelligence (AI) planning, incrementally populating the user interface with different dedicated content areas for different objectives of the cloud implementation, incrementally detecting content that is added to the different dedicated content areas of the user interface via user devices of a collaboration of users, detecting votes submitted via the user interface by the user devices regarding the detected content, and generating an ordered sequence of actions to perform for implementing a cloud platform and displaying the ordered sequence of actions via the user interface.

### BRIEF DESCRIPTION OF THE DRAWINGS

FIG. 1 is a diagram illustrating a cloud computing environment that interacts with various devices according to an example embodiment.

FIG. 2A is a diagram illustrating abstraction model layers of a cloud computing environment according to an example embodiment.

FIG. 2B is a diagram illustrating a computing environment for a data and artificial intelligence (AI) strategy framework according to an example embodiment.

FIGS. 3A-3C are diagrams illustrating examples of a permissioned network according to example embodiments.

FIG. 3D is a diagram illustrating machine learning process via a cloud computing platform according to an example embodiment.

FIG. 3E is a diagram illustrating a quantum computing environment associated with a cloud computing platform according to an example embodiment.

FIGS. 4A-4E are diagrams illustrating an incremental process for capturing priorities and objectives and building a data and AI strategy according to example embodiments.

FIG. 5 is a diagram illustrating a method of incrementally developing an action plan for data and AI strategy of a cloud platform according to an example embodiment.

FIG. 6 is a diagram illustrating an example of a computing system that supports one or more of the example embodiments.

### DETAILED DESCRIPTION

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

The example embodiments are directed to a system that can provide an electronic workspace (digital workspace) where different groups of users may collaborate on a rapid and incremental development of a data and AI strategy that can be used to build a cloud data and AI platform or provide an incremental update/enhancement to such platform's current state. The host may incrementally reveal additional areas for receiving content of differing kinds. Initially, the host may provide a dedicated content area for broad goals such as data needs (data criteria), objectives and priorities of the individual groups within an organization. Each group, via a user device, may access the workspace and post notes or other digital content inside of the workspace so that other users that are collaborating on the strategy can view and elaborate on the posted content.

The host may capture content posted by all groups on the workspace over a period of time and expose an additional dedicated content area that requests more detailed information from the groups such as the business use cases, the predictions/models that are likely to be needed, the blocking factors, and the like. Here, the blocking factors may refer to problems or other issues that may prevent or otherwise limit the group from achieving its goals and objectives. The blocking factors may refer to data such as insufficiency, inaccuracy, untimely, etc. As another example, blocking factors may refer to people or organizational dynamics. As another example, blocking factors may refer to regulatory and compliance, technology, and the like. In some embodiments, the host may remove the initial content area for the more general data and replace it with the new dedicated content area for the more detailed data.

In some embodiments, the host may carry some or all of the posted content on a previous screen to a next screen. For example, content posted about one or more of data and AI criteria, objectives, and priorities may be extracted from a prior screen and populate onto a next screen enabling the users to view the previous submissions.

The host may also request votes and preferences from the different groups, tabulate the votes, and generate an action plan for data and AI strategy that can be incorporated into a document such as an architecture document and/or displayed on the workspace. At each of the collaborative workspaces described herein (which may be in sequence), areas of shared need (data, blocking factors, AI/measures/KPIs/predictions, technology components) are identified from multiple business objectives and multiple business use cases. When one of these factors impacts/is needed by more than one business use case, it delivers greater business value. The intersectionof each component helps to determine a set of possible starting points. Blocking factors help determine the feasibility of each starting point to then select the starting point. From a cloud perspective, the output from a data and AI strategy is an action plan help to drive an overall technical reference architecture, including deployment architectures (Cloud, Multi-Cloud, Hybrid Cloud, on-premise). The action plan may be displayed on the screen or embedded into another document such as a technical reference document.

In the example embodiments, “data and AI strategy” refers to a sequence of instructions or actions within a plan for an organization to meet stated objectives with data assets and AI capabilities (analytics, prediction, data science, artificial intelligence). These actions are used to configure the cloud implementation. In the example embodiments, an automated platform hosted by a central system can collect, organize, and prioritize information needed to develop a data and AI strategy which is aligned to the business strategy in a very concise, iterative, and expedient manner. The sequence of steps and exercises may be used to build an actionable (implementable) data and AI strategy based on high-level business objectives and priorities/ranking (“level 1”), more specific business use cases and priorities (“level 2”), opportunities, blocking factors, data requirements and criteria needs, measures, AI, stakeholders, users, and the like. The strategy may also include a data topology that illustrates or otherwise describes how data is organized, consumed, and stored, as well as the flow of data. In addition, the AI need (analytics, prediction, data science, artificial intelligence) may be described herein and used to provide accurate, locatable, and usable data to deliver business outcomes.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Examples of cloud computing characteristics that may be associated with the example embodiments include the following.

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Examples of service models that may be associated with the example embodiments include the following:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Examples of deployment models that may be associated with the example embodiments include the following:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

According to various embodiments, the host system described herein may output a user interface that includes a digital content area where users can post content such as placing digital content (e.g., digital notes, images, cards, placard, documents, etc.) on a digital whiteboard or other workspace. The digital content area may include predefined content areas such as boxes, rectangles, areas, spaces, etc. within the digital workspace that are dedicated for particular types of posted content. The users may include user devices that are associated with different groups (sub-units) within an organization which work together to create a cross-functional data and AI strategy for implementing a cloud platform.

The host system may iteratively display dedicated content areas for more specific types of data, capture the posted content in the different dedicated content areas, capture votes on the posted content, and build a data and AI strategy that can be displayed via the user interface and/or incorporated within a cloud reference architecture document based thereon. Initially, the host may display dedicated content areas (e.g., via a first screen, etc.) for more generic or general types of content such as objectives/priorities, data needs (data criteria), measures, key performance indicators (KPIs), people/stakeholders, and the like. This type of data may begin the creative process.

As content is posted to the digital content area by the different groups on the first screen, the host platform may display additional dedicated content areas (e.g., via a different/second screen or the same screen, etc.) with requests for more specific/subjective information such as business use cases, blocking factors, and the like, which may be used to further refine the data previously captured. This iterative process can continue to and the host platform may display additional rounds of dedicated content areas (e.g., via a third screen, etc.) which includes dedicated content areas for technical enablers, technical objectives, and the like. In addition, the host platform may carry data from a dedicated content area on a previous screen to a next screen. For example, one or more dedicated content areas from the first screen may be reconstructed and displayed via one or more of the additional screens.

The posted content may include text content, images, documents, etc. The content may also include descriptions of models such as artificial intelligence models, machine learning models, and the like. The posted content may be collected and analyzed by the host platform. Furthermore, the host platform may display voting boxes or the like on the user interface which allows the different groups to vote or otherwise vote on what suggested content, steps, AI, data needs, and the like, goes into the final data and AI strategy. The host may capture this information and generate an actionable plan for data and AI strategy that can be incorporated into a cloud reference architecture document and/or displayed on the user interface.

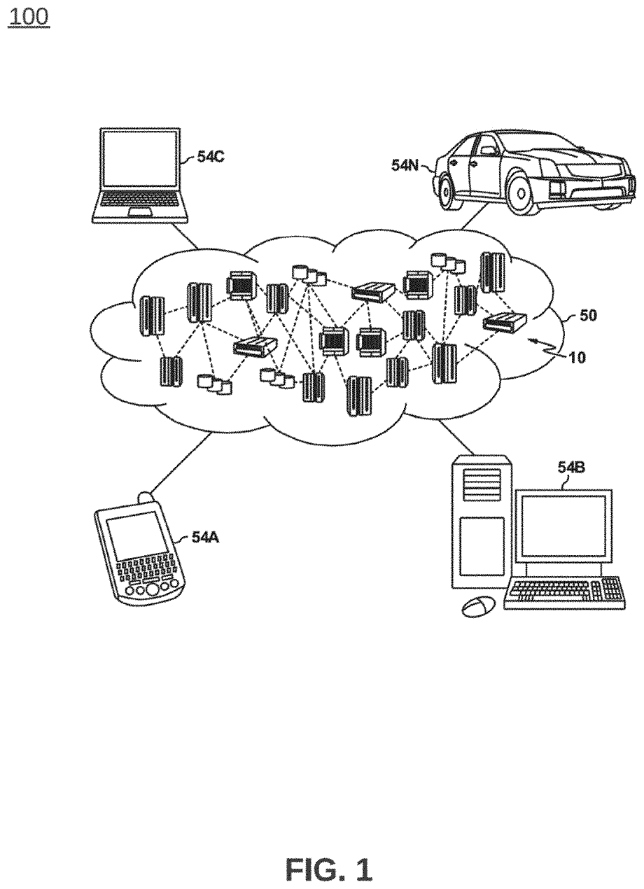

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Cloud computing nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that cloud computing nodes 10 and cloud computing environment 50 can communicate with any type of computerized device over any type of network and/or network addressable connection (e.g., using a web browser).

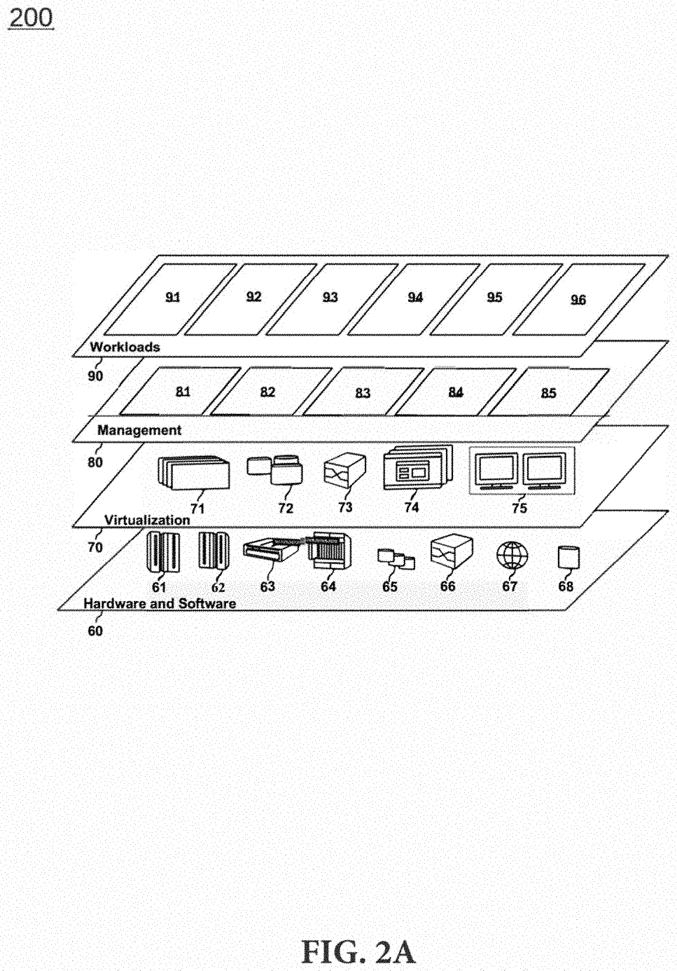

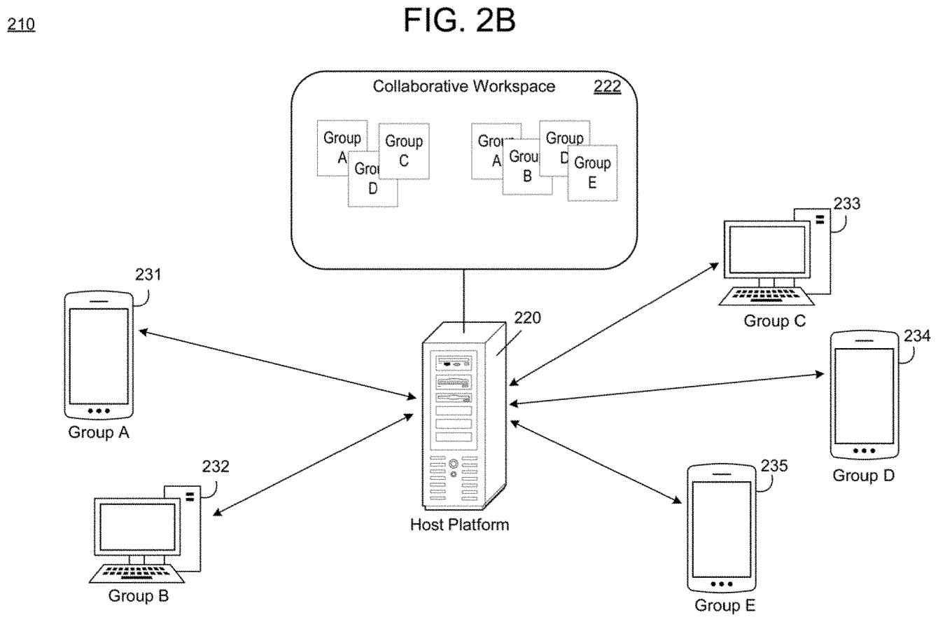

Referring now to FIG. 2A, a set of functional abstraction layers provided by cloud computing environment 50 (FIG. 1) is shown. It should be understood in advance that the components, layers, and functions shown in FIG. 2A are intended to be illustrative only and embodiments of the invention are not limited thereto. As depicted, the following layers and corresponding functions are provided: Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and data and AI strategy creation process 96.

FIG. 2B illustrates a computing environment 210 of a host platform 220 that hosts a data and artificial intelligence (AI) strategy framework according to an example embodiment. For example, the host platform 220 of FIG. 2B may host the data and AI strategy creation process 96 that is described in FIG. 2A. Referring to FIG. 2B, the host platform 220 may be a web server, a cloud platform, a user device, a database, a blockchain network, or the like. The host platform 220 may generate and display a collaborative workspace 222 via a web address such as a uniform resource locator (URL). A plurality of user devices 231-235 may connect to the host platform 220 via the Internet, and use the data connection with the host platform 220 established via the Internet to access the collaborative workspace 222 at the web address via a web browser, a mobile application, or the like. As just one example, the host platform 220 may host a progressive web application (PWA) that provides the collaborative workspace 222.

In some embodiments, the collaborative workspace 222 may be a digital workspace such as a digital whiteboard or the like where the user devices 231-235 can post content such as post-it notes, images, documents, and the like. Furthermore, the collaborative workspace 222 may also provide voting buttons or options therein for the user devices 231-235 to vote on posted criteria such as priorities, data needs, objectives, business uses cases, blocking factors, technical enablers, and the like.

The host platform 220 may incrementally display different dedicated areas for posting content. For example, the host platform 220 may request more general information from the groups during an initial round of dedicated content areas. After receiving posted content for the first round of dedicated content areas, the host platform 220 may remove the first round of dedicated content areas and display a second round of dedicated content areas which requests more detailed information that can be used to refine the first round of posted content. This process may be repeated any number of desired times. However, in some embodiments, the host platform 220 may pull content posted on a previous screen and display it on a next screen with an additional round of dedicated questions to give the users/groups a full understanding of the content that has been posted so far.

Next, the host platform 220 may be used to identify technical objectives and priorities (short-term tactical and longer-term strategic) based on other content submitted via the collaborative workspace 222. Furthermore, the host platform 220 may be used to align each technical objective to a posted business use case (opportunity) and identify needed technical enablers. Furthermore, the host platform 220 may be used to group shared technical enablers across multiple opportunities and groups (business use cases). The technical enablers may be displayed and used to decide on an actionable starting point for the data and AI Strategy action plan, as well as the order of instructions for carrying out the data and AI strategy actions. Each instruction may include an owner, a task, a time at when it should be completed, and the like.

The example embodiments provide a significant advantage over traditional data and AI implementation of a cloud platform which is typically performed by a developer in isolation with individual groups. In contrast, in the example embodiments, a collaborative workspace can be provided and made centrally accessible via the Internet or other network thereby allowing multiple user devices to simultaneously collaborate on the data and AI strategy essentially creating a single “virtual” room where different groups within an organization can communicate and create a data and AI strategy, and if necessary, vote on differences in priority, objective, etc.

Furthermore, the host platform 220 may update/populate the collaborative workspace 222 with various dedicated content areas, detect content posted to the content areas, and store the content. Furthermore, the collaborative workspace 222 can be used to build an actionable plan for data and AI strategy implementation for a cloud platform. The host can speed up the process through the centralized and always available collaborative workspace 222. Furthermore, the host platform 220 can expedite the process with dedicated content areas, timers and other features to ensure rapid and incremental data capture and analysis. Thus, the time for creating an action plan for data and AI strategy can be shortened to a few days/weeks rather than months.

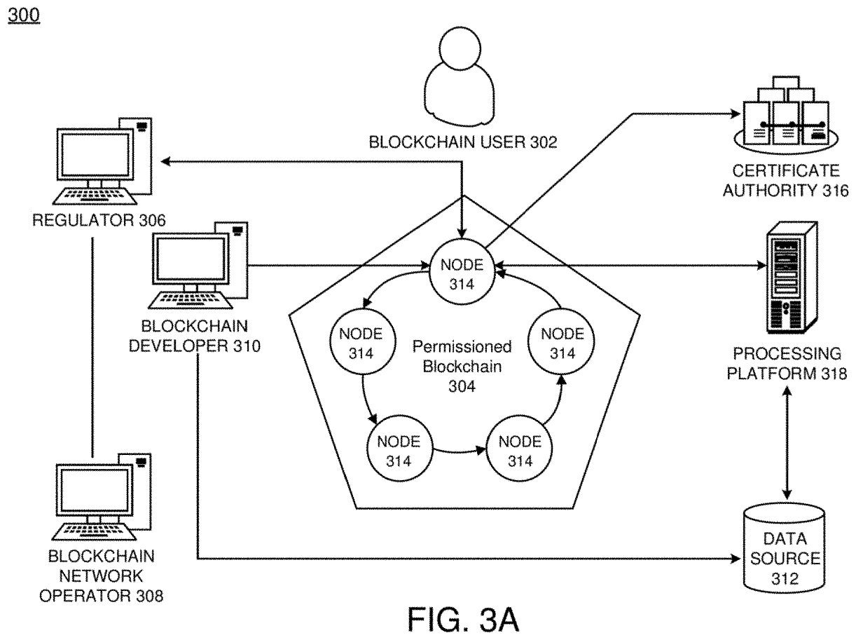

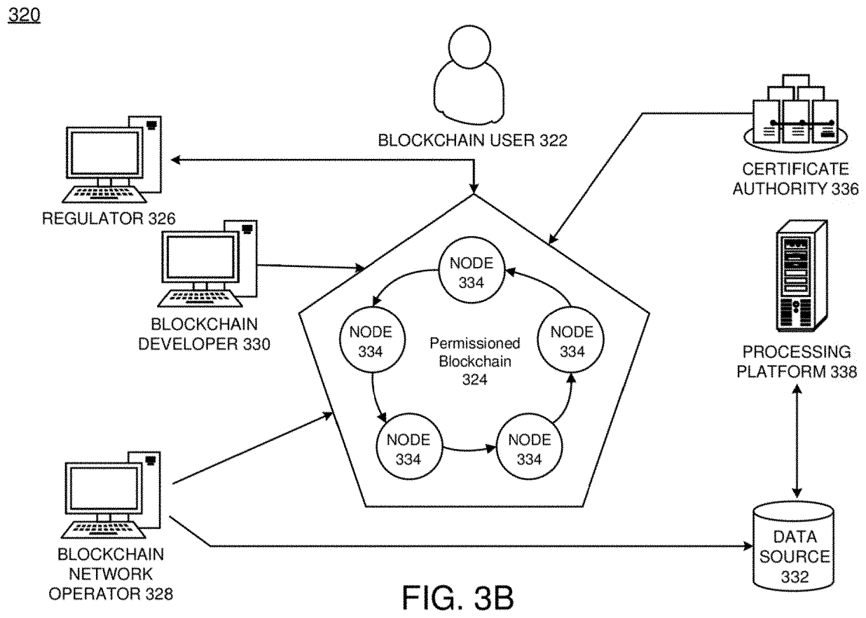

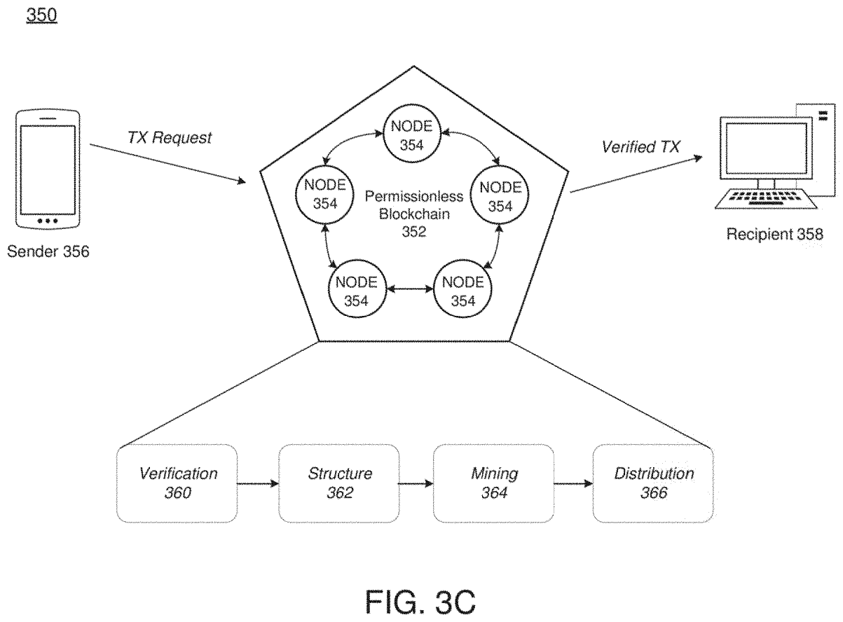

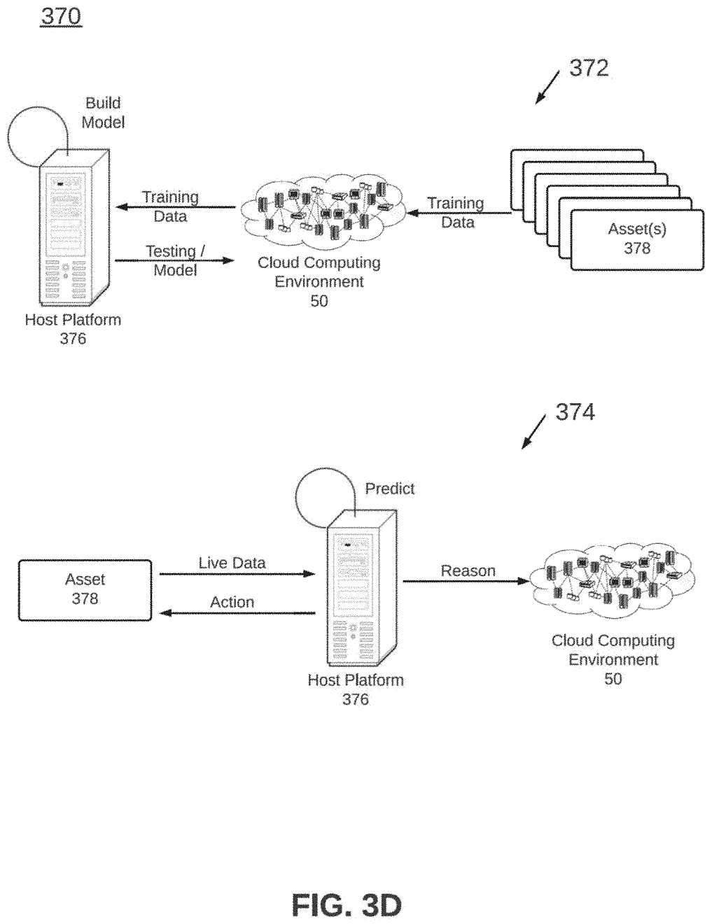

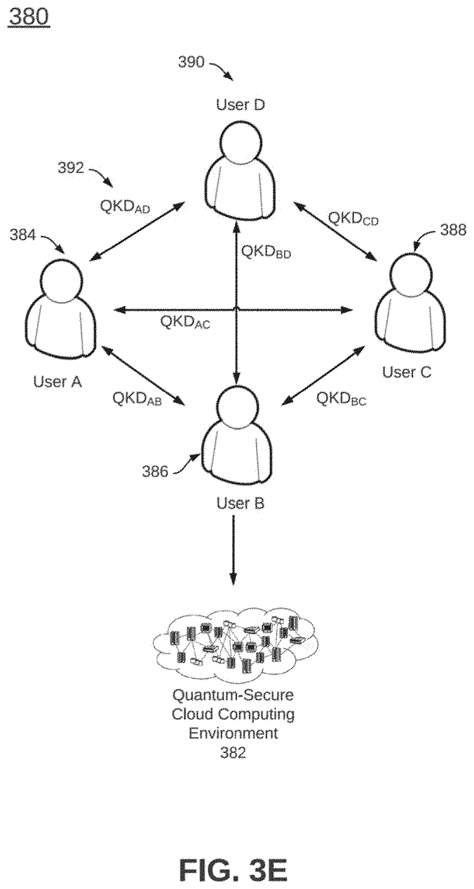

FIGS. 3A-3E provide various examples of additional features that may be used in association with the cloud computing environment.

FIG. 3A illustrates an example of a permissioned blockchain network 300, which features a distributed, decentralized peer-to-peer architecture. The blockchain network may interact with the cloud computing environment 50, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 366, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 50 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376 builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 50 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 50. This can significantly reduce the collection time needed by the host platform 376 when performing predictive model training. For example, data can be directly and reliably transferred straight from its place of origin to the cloud computing environment 50. By using the cloud computing environment 50 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the data associated therewith) may be stored on the cloud computing environment 50 by the host platform 376. Each refinement of the machine learning model (e.g., changes in variables, weights, etc.) may be stored in the cloud computing environment 50 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 50.

After the model has been trained, it may be deployed to a live environment where it can make predictions/decisions based on the execution of the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by the execution of the machine learning model at the host platform 376 may be stored on the cloud computing environment 50 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 50. In one embodiment the features and/or the actions described and/or depicted herein can occur on or with respect to the cloud computing environment 50.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender, and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used including QKDAB, QKDAc, QKDAD, QKDBc, QKDBD, and QKDcD. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions, and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 384-390) authenticate the transaction by providing their shared secret key 392 (QKD). This quantum signature can be attached to every transaction making it exceedingly difficult to be tampered with. Each node checks its entries with respect to a local copy of the cloud computing environment 382 to verify that each transaction has sufficient funds.

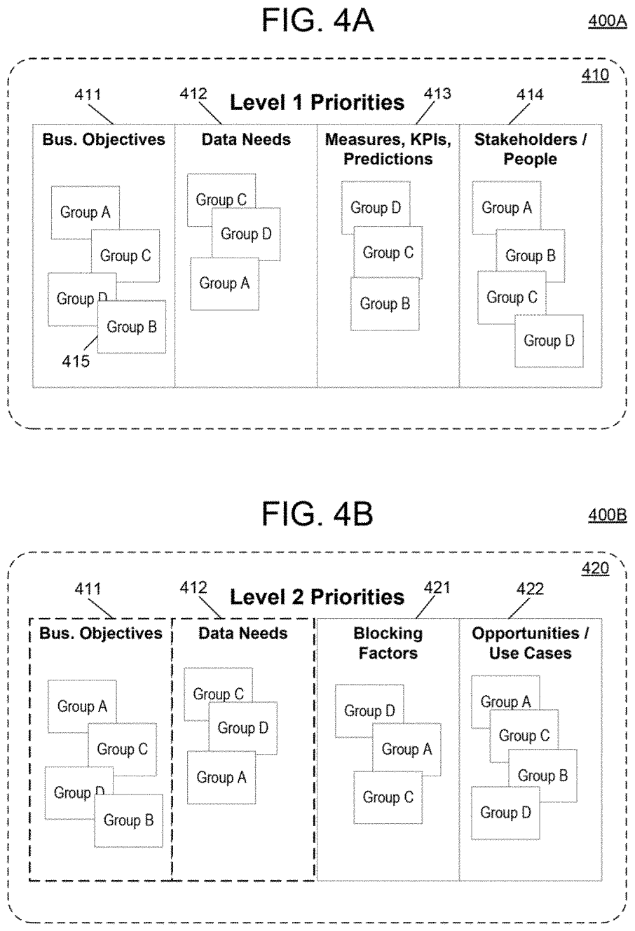

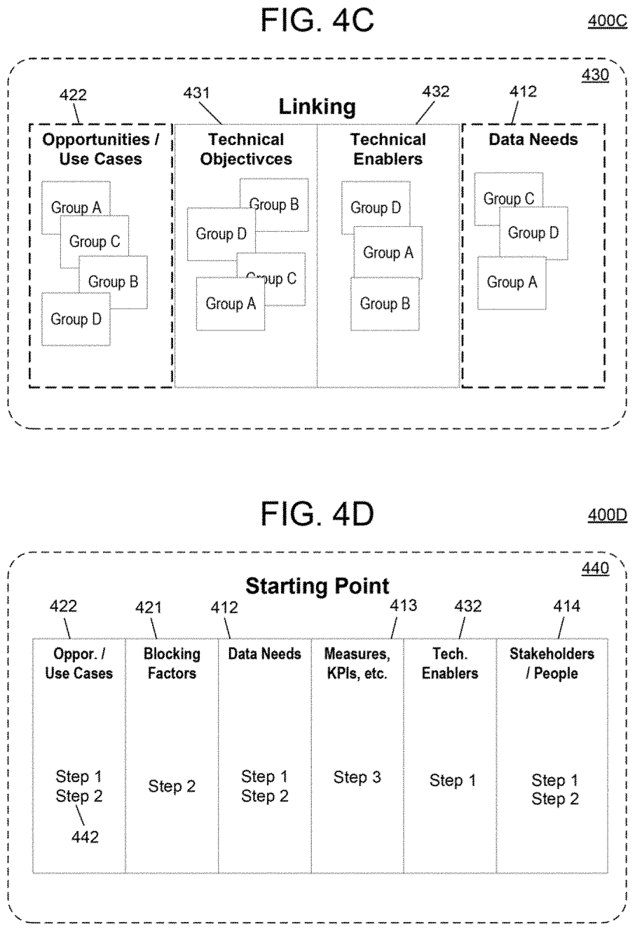

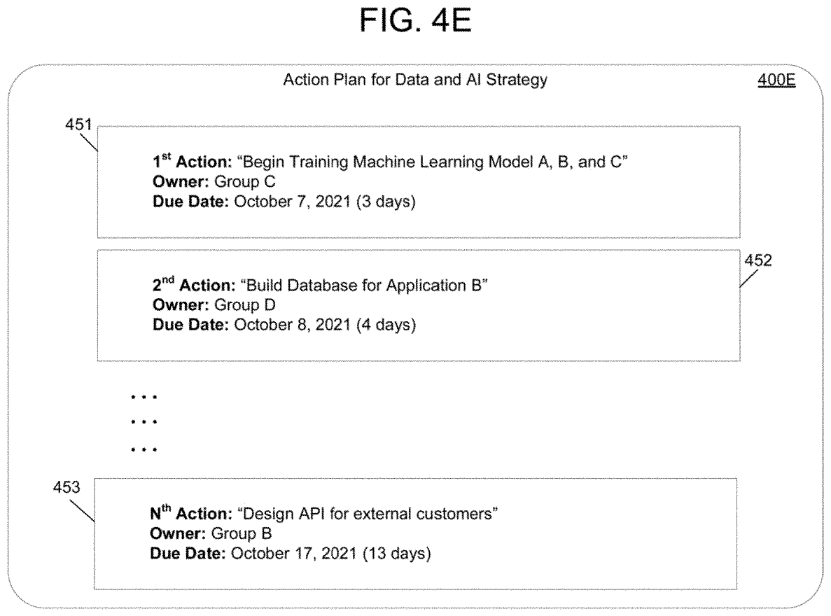

FIGS. 4A-4E illustrate an example of an incremental process for capturing priorities among objectives across multiple groups of a complex business organization and building a data and AI strategy according to example embodiments. It should be appreciated that the computing environment in which the process occurs may be different than what is described and shown herein. It should also be understood that the particular content requested during each increment may be different. The example embodiments host a collaborative process for building/developing a data and AI strategy for cloud platform implementation. In some embodiments, the host platform may embody the collaborative workspace with dedicated content posting areas for generic attributes of a data and AI strategy, and incrementally refine the generic attributes with more specific attributes based on more specific dedicated content posting areas.

The process described herein may incrementally develop a data and AI strategy while identifying actionable, viable, cross-functional starting points and new and enhanced capabilities to deliver value against a set of given business objectives. A sequence/series of exercises capture and organize information that can be used to develop an actionable, incremental data and AI strategy. At each step, critical success factors for data and AI implementation are captured with increasing degree of detail to determine how to deliver business functionality in an expedient and impactful manner.

FIG. 4A illustrates an example of a user interface 400A that may be displayed by the host system described herein. Here, the user interface 400A may refer to a digital online whiteboard, a sticky note platform, or the like. As another example, the user interface 400A may refer to a web page where content can be posted by externally connected inside predefined content areas.

Referring to FIG. 4A, the user interface 400A includes a first collaborative workspace 410 embedded therein such as the digital whiteboard or the sticky note platform. The first collaborative workspace 410 includes dedicated content areas 411, 412, 413, and 414, which are predefined for specific types of content. In this example, dedicated content area 411 is dedicated to objectives that can be prioritized through votes received via the collaborative workspace 410, dedicated content area 412 is dedicated to data criteria or needs, dedicated content area 413 is dedicated to AI-based needs such as measures, KPIs, predictive algorithms and/or functions, etc., and dedicated content area 414 is dedicated to stakeholders and people associated with the platform.

External users may access a URL or other IP address where the first collaborative workspace 410 is hosted by the host platform and post content into the dedicated content areas 411, 412, 413, and 414. For example, different groups within a complex organization may have a dedicated device or user for posting content to the first collaborative workspace 410. The posted content may include online post-it notes or sticky-notes. As another example, the posted content may include text content input into embedded content areas of a web page.

The first collaborative workspace 410 may be used for assembling the cross-functional team of stakeholders and subject matter experts together, understanding business strategy and general priorities, independent of technology and current inhibitors, opening a pool of actionable candidates across multiple business use cases, surfacing shared data needs across multiple business use cases, capturing measures/KPIs/predictions required, identifying stakeholders and people involved, and the like.

FIG. 4B illustrates an example of a user interface 400B illustrating a second collaborative workspace 420. Here, the second collaborative workspace 420 may be displayed in sequence with the first collaborative workspace 410. For example, the host platform may start a timer or otherwise keep a record of when the first collaborative workspace 410 is displayed and wait for a predetermined amount of time to elapse and then remove the first collaborative workspace 410 and replace it with the second collaborative workspace 420 (e.g., at the same web page, etc.)

In some embodiments, the host platform may carry over some or all of the dedicated content areas 411, 412, 413, 414, etc., from the collaborative workspace 410 to the second collaborative workspace 420. In the example of FIG. 4B, the dedicated content areas 411 and 412, and the content posted therein by the user groups, is carried over to the second collaborative workspace 420 which includes additional dedicated content areas 421 and 422 dedicated to blocking factors (e.g., obstacles in the way of achieving a given objective, etc.) and use cases, respectively. Blocking factors may include technology, data, people, current business process, regulations, etc. In the example embodiments, the blocking factors may be uniquely grouped/rearranged via the collaborative workspace 410 to be associated with each objective to determine what blocking factors are shared across multiple objectives and eventually how they can be removed or mitigated consistently across the multiple objectives. For example, virtual/digital notes can be rearranged on the digital whiteboard.

The second collaborative workspace 420 may be used for grouping together and prioritizing blocking factors from various groups of the organization to achieve objectives against additional business use cases of the groups of the organization, surfacing shared blocking factors across multiple business use cases, refining shared data needs, refining the measures/KPIs/predictions, refining stakeholders and people across multiple additional business use cases, and the like. In the second collaborative workspace 420, dedicated content areas for data needs 412 and blocking factors 421 may be arranged next to each other and used for aligning (i.e., lining up between the two dedicated content areas) data needs and blocking factors of each of the groups. This can then be used to identify data needs and blocking factors that affect multiple groups which may potentially be good starting points for the data and AI strategy.

FIG. 4C illustrates an example of a user interface 400C illustrating a third collaborative workspace 430. Here, the third collaborative workspace 430 may be displayed in sequence with the second collaborative workspace 420 and the first collaborative workspace 410. For example, the host platform may start a timer or otherwise keep a record of when the first/second collaborative workspace 410/420 is displayed and wait for a predetermined amount of time to elapse and then replace it with the third collaborative workspace 430 (e.g., at the same web page, etc.)

In some embodiments, the host platform may carry over some or all of the dedicated content areas from either of the first and second collaborative workspaces 410 and 420 to the third collaborative workspace 430. In the example of FIG. 4C, the dedicated content areas 412 and 422 dedicated to data criteria/needs and business use cases, respectively, and the content posted therein by the user groups, is carried over to the third collaborative workspace 430 which includes additional dedicated content areas 431 and 422 dedicated to technical objectives and technical enablers (e.g., software to satisfy the technical objectives, etc.), respectively. For example, the third collaborative workspace 430 may be used for linking technology enablers to address business challenges and remedy blocking factors, and the like.

FIG. 4D illustrates an example of a fourth collaborative workspace 440 embedded within a user interface 400D. Here, the fourth collaborative workspace 440 may be displayed in sequence with the third collaborative workspace 430, the second collaborative workspace 420, and the first collaborative workspace 410. In this example, the fourth collaborative workspace 440 is used to determine a starting point for the data and AI strategy action plan. In other words, a first step or steps to be performed as part of the plan can be identified and possibly voted on if necessary. In this example, content areas 412, 413, 414, 421, 422, and 432, are shown, but additional content may be used.

The fourth collaborative workspace 440 may be used for identifying a most viable/feasible starting point of a new action plan or incremental enhanced capabilities of a previous action plan with blocking factor remedies and greatest impact (value) across multiple business use cases Furthermore, based on cross-functional requirements captured in the previous steps, the groups of users can use the fourth collaborative workspace 440 to decide each of the remaining steps in the action plan in an incremental fashion. Here, the cross-functional needs may refer to assets (data) and technology (capabilities) that are needed by multiple business use cases in order to deliver valuable outcomes.

An example of a data and AI strategy action plan is shown in action plan 450 in FIG. 4E. In this example, the action plan 450 includes a plurality of instructions/steps that are to be performed in a particular order including instructions 451, 452, and 453. Some of the instructions may be performed at the same time and some may be dependent on other instructions to complete before they start. Each instruction 451, 452, and 453 may include a description of the action to be performed, an owner of the action, a due date, an ordering of the instruction with respect to other instructions, and the like.

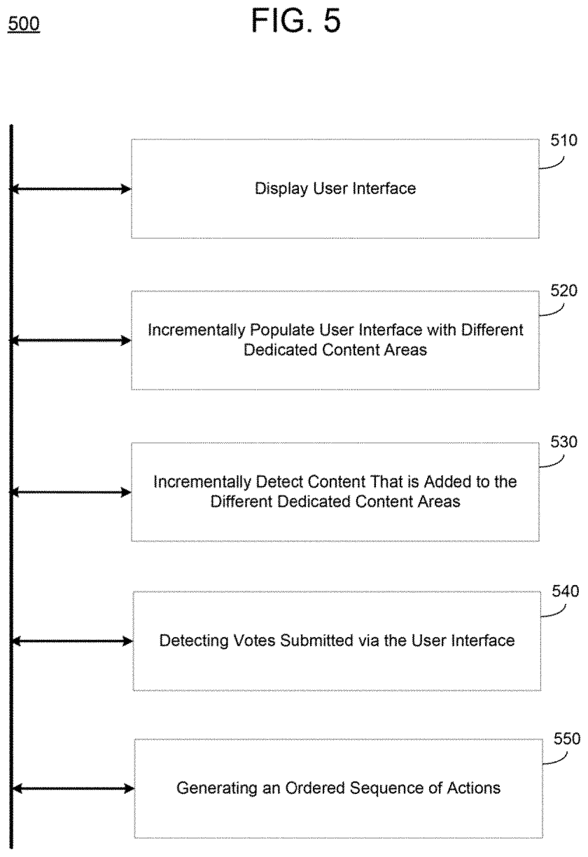

FIG. 5 illustrates a method 500 of incrementally developing an action plan for data and AI strategy of a cloud platform according to an example embodiment. Referring to FIG. 5, in 510 the method may include displaying, via a uniform resource location (URL), a user interface for data and artificial intelligence (AI) planning of a cloud implementation. In 520, the method may include incrementally populating the user interface with different dedicated content areas for different objectives of the cloud implementation.

In 530, the method may include incrementally detecting content that is added to the different dedicated content areas of the user interface via user devices of a collaboration of users. In 540, the method may include detecting votes submitted via the user interface by the user devices regarding the detected content. In 550, the method may include generating an ordered sequence of actions to perform for implementing a cloud platform and displaying the ordered sequence of actions via the user interface.

In some embodiments, the incrementally populating may include initially populating the user interface with a first dedicated content area for one or more of data criteria, key performance indicators (KPIs), stakeholders, and prediction criteria, detecting a first subset of content that is added to the dedicated content area, and storing the first subset of content in the memory. In some embodiments, the incrementally populating may further include sequentially populating the user interface with a second dedicated content area for one or more of use cases and blocking factors, after detecting the first and second subsets of content, detecting a second subset of content that is added to the second dedicated content area, and storing the second subset of content in the memory.

In some embodiments, the incrementally populating further comprises sequentially populating the user interface with a third dedicated content area for one or more of technical enablers and technical objectives, after detecting the second subset of content, detecting a third subset of content that is added to the third dedicated content area, and storing the third subset of content in the memory. In some embodiments, the incrementally populating may further include populating the user interface with a fourth dedicated content area for receiving requests for a cross-functional starting instruction for the sequence of instructions.]

In some embodiments, the detecting may include detecting online notes that are posted to one or more of an online whiteboard and an online sticky note board within the user interface. In some embodiments, an instruction within the ordered sequence of instructions may include a description of an action to be performed, a respective owner, and a respective due date, which are displayed via the user interface. In some embodiments, the user interface may be hosted by a web server, and the user devices connect to the user interface and post content to the user interface via respective web browsers on the user devices.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

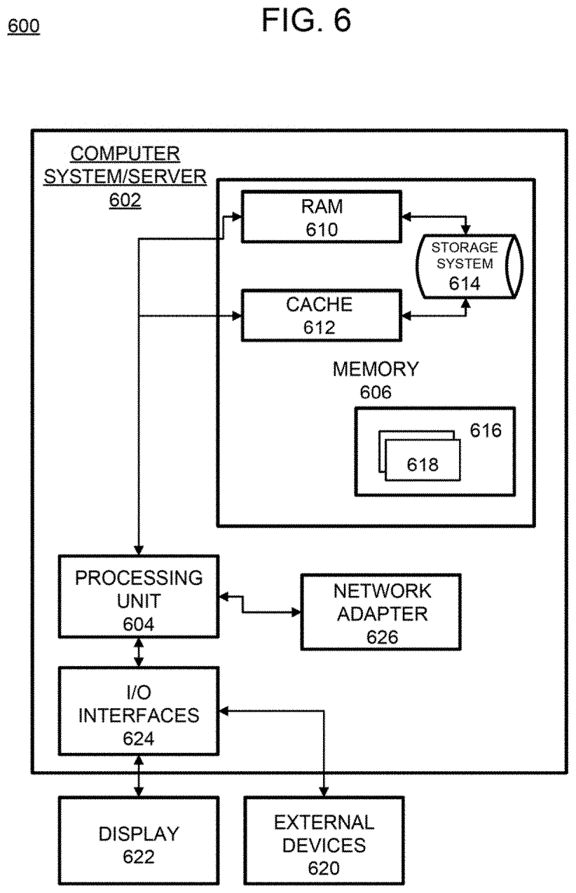

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, etc.

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in cloud computing node 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. An apparatus comprising:
a memory configured to store program instructions; and
a processor coupled to the memory and configured to execute the program instructions, wherein, in response to execution of the program instructions, the processor is configured to:
display, via a uniform resource location (URL), a user interface for data and artificial intelligence (AI) planning,
incrementally populate the user interface with different dedicated content areas for different objectives of a cloud implementation,
incrementally detect content that is added to the different dedicated content areas of the user interface via user devices of a collaboration of users,
detect votes submitted via the user interface by the user devices regarding the detected content, and
generate an ordered sequence of actions to perform for implementing a cloud platform and display the ordered sequence of actions via the user interface.

2. The apparatus of claim 1, wherein the processor is configured to initially populate the user interface with a first dedicated content area for one or more business objectives, data criteria, key performance indicators (KPIs), stakeholders, and prediction criteria, detect a first subset of content that is added to the dedicated content area, and store the first subset of content in the memory.

3. The apparatus of claim 2, wherein the processor is further configured to sequentially populate the user interface with a second dedicated content area for one or more of use cases and blocking factors, after detecting the first and second subsets of content, detect a second subset of content that is added to the second dedicated content area, and store the second subset of content in the memory.

4. The apparatus of claim 3, wherein the processor is further configured to sequentially populate the user interface with a third dedicated content area for one or more of technical enablers and technical objectives, after detecting the second subset of content, detect a third subset of content that is added to the third dedicated content area, and store the third subset of content in the memory.

5. The apparatus of claim 4, wherein the processor is further configured to populate the user interface with a fourth dedicated content area for receiving requests for a cross-functional starting instruction for the sequence of instructions.

6. The apparatus of claim 1, wherein the processor is configured to detect notes that are posted to one or more of an online whiteboard and an online sticky note board within the user interface.

7. The apparatus of claim 1, wherein an instruction within the ordered sequence of instructions includes a description of an action to be performed, a respective owner, and a respective due date, which are displayed via the user interface.

8. The apparatus of claim 1, wherein the user interface is hosted by a web server, and the user devices connect to the user interface and post content to the user interface via respective web browsers on the user devices.

9. A method comprising:
displaying, via a uniform resource location (URL), a user interface for data and artificial intelligence (AI) planning;
incrementally populating the user interface with different dedicated content areas for different objectives of a cloud implementation;
incrementally detecting content that is added to the different dedicated content areas of the user interface via user devices of a collaboration of users,
detecting votes submitted via the user interface by the user devices regarding the detected content; and
generating an ordered sequence of actions to perform for implementing a cloud platform and displaying the ordered sequence of actions via the user interface.

10. The method of claim 9, wherein the incrementally populating comprises initially populating the user interface with a first dedicated content area for one or more of business objectives, data criteria, key performance indicators (KPIs), stakeholders, and prediction criteria, detecting a first subset of content that is added to the dedicated content area, and storing the first subset of content in the memory.

11. The method of claim 10, wherein the incrementally populating further comprises sequentially populating the user interface with a second dedicated content area for one or more of use cases and blocking factors, after detecting the first and second subsets of content, detecting a second subset of content that is added to the second dedicated content area, and storing the second subset of content in the memory.

12. The method of claim 11, wherein the incrementally populating further comprises sequentially populating the user interface with a third dedicated content area for one or more of technical enablers and technical objectives, after detecting the second subset of content, detecting a third subset of content that is added to the third dedicated content area, and storing the third subset of content in the memory.

13. The method of claim 12, wherein the incrementally populating further comprises populating the user interface with a fourth dedicated content area for receiving requests for a cross-functional starting instruction for the sequence of instructions.

14. The method of claim 9, wherein the detecting comprises detecting online notes that are posted to one or more of an online whiteboard and an online sticky note board within the user interface.

15. The method of claim 9, wherein an instruction within the ordered sequence of instructions includes a description of an action to be performed, a respective owner, and a respective due date, which are displayed via the user interface.

16. The method of claim 9, wherein the user interface is hosted by a web server, and the user devices connect to the user interface and post content to the user interface via respective web browsers on the user devices.

17. A computer-readable storage medium comprising instructions, that when read by a processor, cause the processor to perform a method comprising:
displaying, via a uniform resource location (URL), a user interface for data and artificial intelligence (AI) planning;
incrementally populating the user interface with different dedicated content areas for different objectives of a cloud implementation;
incrementally detecting content that is added to the different dedicated content areas of the user interface via user devices of a collaboration of users;
detecting votes submitted via the user interface by the user devices regarding the detected content; and
generating an ordered sequence of actions to perform for implementing a cloud platform and displaying the ordered sequence of actions via the user interface.

18. The computer-readable storage medium of claim 17, wherein the detecting comprises detecting online notes that are posted to one or more of an online whiteboard and an online sticky note board within the user interface.

19. The computer-readable storage medium of claim 17, wherein an instruction within the ordered sequence of instructions includes a description of an action to be performed, a respective owner, and a respective due date, which are displayed via the user interface.

20. The computer-readable storage medium of claim 17, wherein the user interface is hosted by a web server, and the user devices connect to the user interface and post content to the user interface via respective web browsers on the user devices.
